(19) United States
(12) Patent Application Publication
(10) Pub. No.: US 2014/0155160 A1
(43) Pub. Date: Jun. 5, 2014

(54) GAMING SYSTEM PROVIDING A DESTRUCTIBLE GAME OBJECT MECHANIC

(71) Applicant: Zynga Inc., San Francisco, CA (US)

(72) Inventors: Peter Pao Lai, South San Francisco, CA (US); Christopher David Wiggins, San Mateo, CA (US)

(73) Assignee: Zynga Inc., San Francisco, CA (US)

(21) Appl. No.: 14/096,907

(22) Filed: Dec. 4, 2013

Related U.S. Application Data
(60) Provisional application No. 61/733,716, filed on Dec. 5, 2012.

(51) Int. Cl. A63F 13/00

(52) U.S. Cl. CPC A63F 13/005
USPC 463/31

(57) ABSTRACT

A system, computer-readable storage medium storing at least one program, and a computer-implemented method for providing a destructible game object mechanic are presented. For example, an embodiment may generate a destructible game object within a game board assigned to a user. The destructible game object may be represented by an initial state, one or more destructed states, and a reward state. Responsive to detecting a game action that satisfies a part requirement precondition associated with the one or more destructed states, the embodiment may advance the destructible game object from the initial state to the one or more destructed states. Further, responsive to detecting fulfillment of a part requirement precondition associated with the reward state, the embodiment may replace the destructible game object with a reward object.

### CROSS-REFERENCE TO RELATED APPLICATIONS

This application claims priority from U.S. Provisional. Application No. 61/733,716, entitled “Gaming System Providing A Destructible Game Mechanic” and filed Dec. 5, 2012, all of which is incorporated herein by reference in its entirety for all purposes.

### TECHNICAL FIELD

The present disclosure relates to gaming systems. In particular, an example gaming system provides a destructible game object mechanic.

### BACKGROUND

Traditional game systems may allow a user to obtain a game object through buildable game objects. Commonly, traditional game systems may cause a buildable game objects to appear on a user's game board in an incomplete state. For example, a building may appear as a construction area. In conjunction with placing the buildable game object on the board, the traditional system may provide a visual indication of a finished state for the buildable game object, along with a recipe (e.g., parts, such as bricks and metals) used to transition the buildable game object to the finished state. To transition the buildable game object from an incomplete state to a finished state, the user may add parts, as may be shown by the recipe, to the buildable game object. For example, the user may add bricks and metal pieces until a determinable number of parts have been added. Once the determinable number of parts is reached, the traditional game system may move the buildable game object to the finished state.

Thus, traditional game systems may provide a buildable game object where a user adds parts to transition the buildable object to a known finished state.

### BRIEF DESCRIPTION OF THE DRAWINGS

The present disclosure is illustrated by way of example, and not limitation, in the figures of the accompanying drawings, in which like reference numerals indicate similar elements unless otherwise indicated. In the drawings,

FIG. 1 is a system diagram illustrating an example of a gaming environment for implementing various example embodiments;

FIG. 2 is a diagram showing an example of a social network within a social graph, according to some embodiments;

FIG. 3 is a diagram showing a visual display of states associated with a destructible game object, according to an example embodiment;

FIG. 4 is a block diagram illustrating modules of a destructible game object computer system that may implement a destructible game object, according to an example embodiment;

FIG. 5 is a flowchart showing a method of providing a destructible game object in a game board, according to an example embodiment;

FIG. 6 is a user interface diagram illustrating a game board that may utilize destructible game objects, according to an example embodiment;

FIG. 7 illustrates an example data flow between example components of the example system of FIG. 1, according to some embodiments;

FIG. 8 illustrates an example network environment, in which various example embodiments may operate; and

FIG. 9 illustrates an example computing system architecture, which may be used to implement one or more of the methodologies described herein, according to some embodiments.

### DESCRIPTION OF EXAMPLE EMBODIMENTS

### Overview

Users of computer-implemented systems may access a gaming system to interact with an online game. For example, a user may access a gaining system, as provided by Zynga, Inc.®, to play an online game that allows users to interact with a destructible game object. For example, the gaming system may place a destructible game object on a game board owned by a user. By way of example and not limitation, the destructible game object may be represented by a block of ice with a treasure chest inside the block of ice. The destructible game object may be associated with an initial state.

Additionally, the game system may generate a visual image of a destruction plan associated with the destructible game object. In some embodiments, the destruction plan may be associated further with the initial state of the destructible game object. With example embodiments, the destruction plan associated with the destructible game object, or the initial state, may list a number parts that are to be applied to the destructible game object to transition the state of the destructible game object to a next state.

In some embodiments, when a user adds the parts to the destructible game object, as requested by the destruction plan, the game system may update the destructible game object to the next state. The next state may be associated with a different visual representation compared to the initial state. For example, the next state may be associated with a relatively smaller image of a block of ice with the treasure chest inside of the block of ice. Additionally, the next state of the destructible game object may be associated with another destruction plan.

In some example embodiments, the user may cause the game system to transition the destructible game object through one or more states before the game system places the destructible game object in a final state. Upon detecting that the destructible game object is at the final state, the game system may cause a reward to appear on the game object. In some embodiments, the reward may be tailored to the user based on user profile data, such as inventory data, game board data, quest data, and the like. By way of example, the game system may select a reward based on a game object usable to advance a quest. To illustrate, a quest may challenge the user to collect a number (e.g., 35) of strawberries, for example. Accordingly, if the user has not completed that challenge, the game system may select strawberries as a reward for the user because that is a type of item needed by the user to complete a challenge in the game.

In some embodiments, the game system may place destructible game objects on a game board of a user when a user expands the game board. Expanding a game board, as used herein, may refer to a game action that unlocks an area of the game hoard. When an area is unlocked, the user may perform game actions on the unlocked area, such as placing buildings, plowing a tile, planting a crop, placing an avatar, or any other suitable game action.

These and other embodiments of the invention are described, by way of example, in further detail below.

### Example System

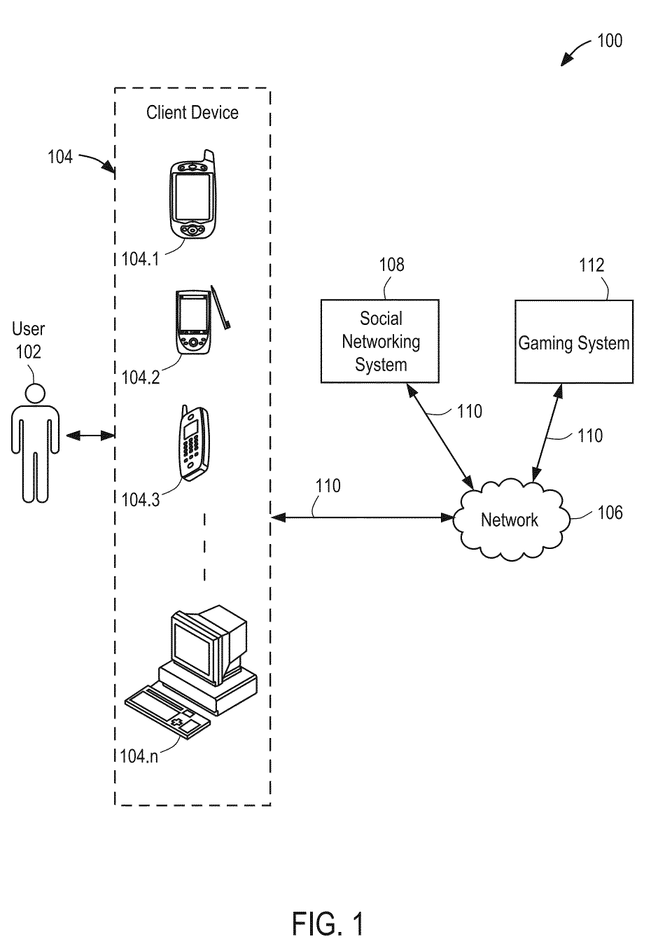

FIG. 1 is a system diagram illustrating an example of a gaming environment 100 for implementing various example embodiments that provide destructible game objects. In some embodiments, the gaming environment 100 comprises a user 102, a client device 104, a network 106, a social networking system 108, and a gaming system 112. The components of the gaming environment 100 may be connected directly or over a network 106, which may be any suitable network. In various embodiments, one or more portions of the network 106 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks.

Although FIG. 1 illustrates a particular example of the arrangement of the user 102, the client device 104, the social networking system 108, the gaming system 112, and the network 106, any suitable arrangement or configuration of the user 102, the client device 104, the social networking system 108, the gaming system 112, and the network 106 may be contemplated.

The client device 104 may be any suitable computing device (e.g., devices 104.1-104.n), such as a smart phone 104.1, a personal digital assistant 104.2, a mobile phone 104.3, a personal computer 104.n, a laptop, a computing tablet, or any other device suitable for playing a virtual game. The client device 104 may access the social networking system 108 or the gaming system 112 directly, via the network 106, or via a third-party system. For example, the client device 104 may access the gaming system 112 via the social networking system 108.

In some embodiments, the client device 104 may be communicatively coupled to or include an input device, such as a keyboard, a pointing device, and a display device (not shown). Such input devices may allow a user to interact with a game provided by the gaming system 112. For example, with the input devices, the client device 104 may allow a user to select (e.g., through a mouse click or a finger tap on a touch screen) a game object.

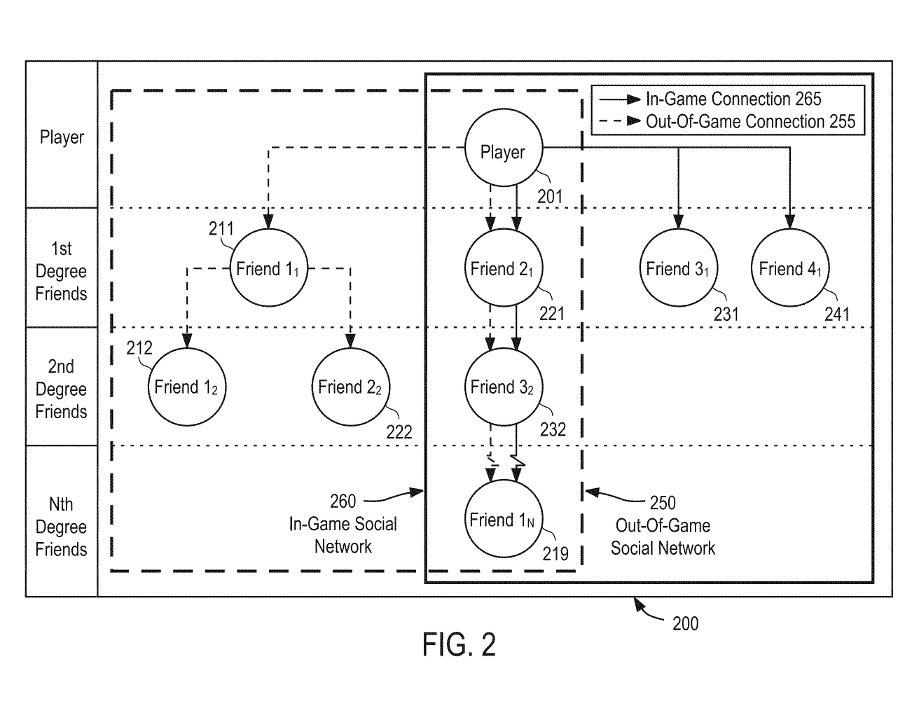

The social networking system 108 may include a network-addressable computing system that can host one or more social graphs (see for example FIG. 2), and may be accessed by the other components of system 100 either directly or via the network 106. The social networking system 108 may generate, store, receive, and transmit social networking data.

FIG. 2 is a diagram showing an example of a social network within a social graph 200. The social graph 200 is shown by way of example to include an out-of-game social network 250 and an in-game social network 260. Moreover, the in-game social network 260 may include one or more users that are friends with Player 201 (e.g., Friend 3₁ 231), and may include one or more other users that are not friends with Player 201. The social graph 200 may correspond to the various users associated with the virtual game. In an example embodiment, player may send game requests to each other. For example, Player 201 may send communication (e.g., a configurable crew request) to Friend 3₁ 231. FIG. 2 and the social graph 200 are described in greater detail below.

With reference back to FIG. 1, the gaming system 112 may include a network-addressable computing system (or systems) that can host one or more online games. The gaming system 112 may generate, store, receive, and transmit game-related data, such as, for example, game account data, game input, game state data, and game displays. The gaming system 112 may be accessed by the other components of the gaming environment 100 either directly or via the network 106. The user 102 may use the client device 104 to access, send data to, and receive data from the social networking system 108 and/or the gaming system 112.

### Example Destructible Game Objects

This section now describes various aspects of a destructible game object, as may be implemented by the gaming system 112, the client device 102, or a combination thereof. It is to be appreciated that the example embodiments described herein are provided merely for illustration and clarity of description. Consequently, the embodiments described here should not be interpreted as limiting the scope of other example embodiments that are consistent with this disclosure.

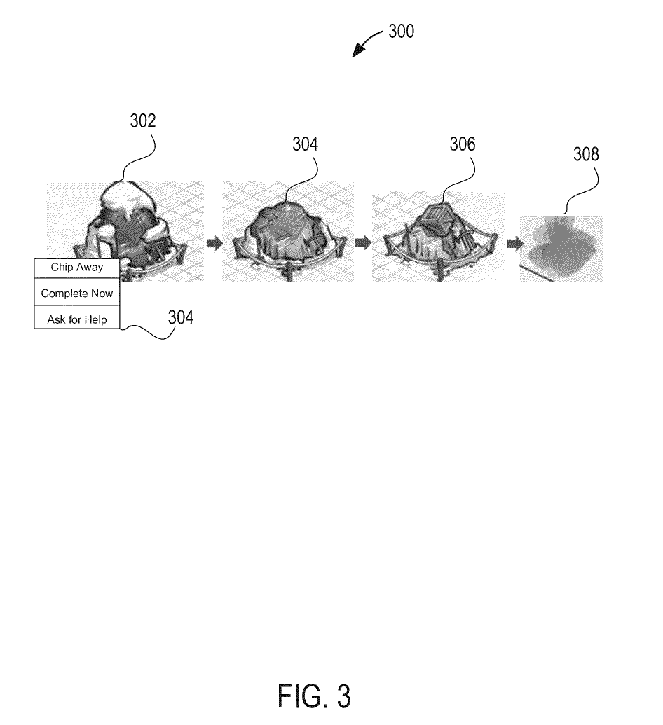

A brief introduction of an example destructible game object is now provided to provide some context to the remaining sections of this disclosure. For example, FIG. 3 is a diagram showing a visual display of states associated with a destructible game object 300, according to an example embodiment. For example, the destructible game object 300 may begin at an initial state 302 and then transition to destructing states 304, 306 until the user finally causes the destructible game object 300 to transition to a reward state 308. The initial state 302 may represent the state of the destructible 300 when the gaming system 100 first places the destructible game object 300 within the game board. The destructing states 304, 306 may be intermediary states the destructible game object 300 enters based on user-initiated destructive game actions being applied to the destructible game object 300. Destructive game actions, in some cases, may be initiated by the user through a game action menu 312, which may be accessible when the destructible game object 300 is any one of the initial state 302 or either of the destructive states 304, 306. Example of destructive game actions that may be initiated through the game action menu 312 include applying a destructive resource to the destructible game object 300, paying a frictionless resource, sending a viral request, and the like.

Each success state from the initial state 302 to the destructive states 304, 306 may be associated with an in-game depiction of the game object that is of decreasing relative size. For example, and not limitation, where positioning of game board is calculated according to cells in a grid, the initial state 302 may correspond to a size of 8×8 tiles, the destructive state 304 may correspond to a size of 6×6 tiles, and the destructive state may correspond to a size of 4×4 tiles.

When the destructible game object 302 transitions to the reward state, the destructible game object 302 may be removed from the game board and be replaced by an in-game reward. In some cases, in-game rewards may be collected and stored in an inventory, be placed in the game board based on a user selection for the location, or be exchanged for an in-game currency or experience point.

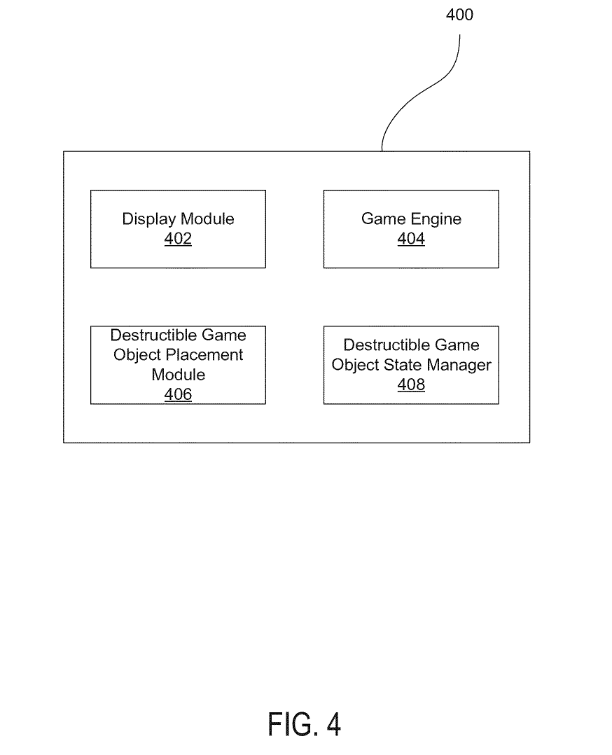

Examples of the modules operable to facilitate destructible game object are now described. For example, FIG. 4 is a block diagram illustrating modules of a destructible game object computer system 400 that may implement a destructible game object, according to an example embodiment. The destructible game object computer system 400 may be one or more computer systems deployed within the components and systems shown in FIG. 1. For example, the destructible game object computer system 400 may be deployed within the client device 104, the gaming system 112, or some combination thereof.

FIG. 4 shows that the destructible game object computer system 400 includes a display module 402, a game engine 404, a destructible game object placement module 406, and a destructible game object state manager 408. The display module 402 may be a computer implemented module configured to generate display data for a game. Display data may refer to data or logic that can be used to generate the visual display of a game. In some embodiments, display data may specify a game environment, which may include one or more game objects to be displayed, the location or coordinates of those game objects, and any visual effects associated with those game objects.

The game engine 404 may be a computer-implemented module configured to process game logic and game data that express the game rules and logic of a game. For example, the game engine 308 may be configured to execute or simulate a game action on a game object, which may in turn involve updating the state of the game object or any other affected part of the game. A game engine is discussed in greater detail below.

The destructible game object placement module 406 may be a computer-implemented module configured to select placements for destructible game objects within a game board. For example, some example embodiments may be configured such that one or more destructible game objects are placed in operable area of the game board. In other cases, the destructible game object placement module 406 may be configured to place one or more destructible game objects in locked game areas of the game board.

The destructible game object state manager 408 may be a computer-implemented module configured to manage or otherwise track the state transitions associated with the destructible game objects in the game board. For example, when a user performs a destructible game action on a destructible game object, the destructible game object state manager 408 may determine whether the destructible game action causes the destructible game object to transition to another state. A state transition may be reflected by updating a visual image associated with the destructible game object. In other cases, a state transition may be reflected by removing the destructible game object from the game board and replacing the destructible game object with a reward game item.

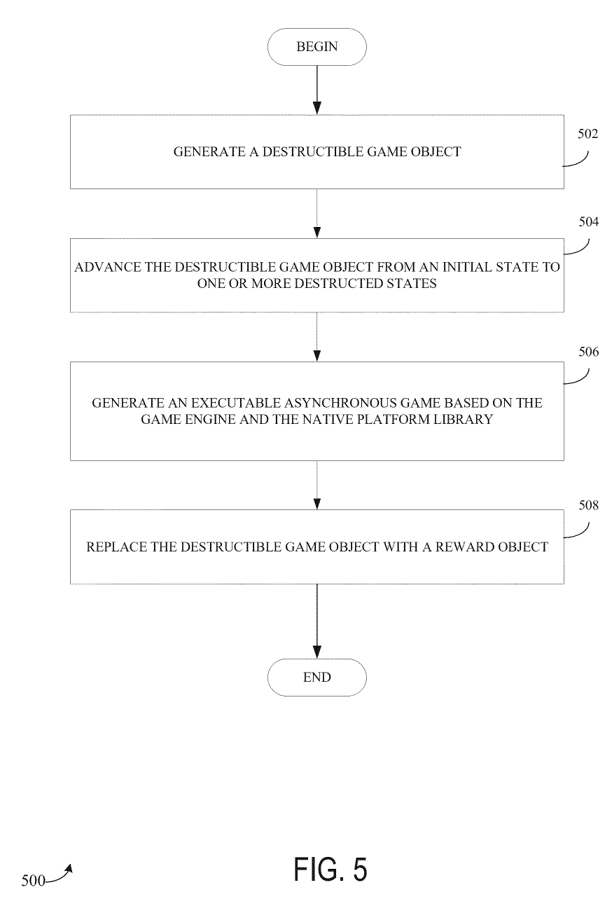

The operation of the destructible game object computer system 400 is now described in greater detail. For example, FIG. 5 is a flowchart showing a method 500 of providing a destructible game object in a game board, according to an example embodiment. In some embodiments, the method 500 is implemented by one or more processors, as may be executed by one or more of the modules shown in FIG. 4.

For example, the method 500 may begin at operation 502 when the destructible game object placement module 406 generates a destructible game object at a location within a game board. In some cases, the destructible game object placement module 406 may generate the destructible game object at a location that may be expanded by the user playing the game. In other cases, the destructible game object may be placed at a location that is accessible to the user playing the game.

At operation 504, the destructible game object state manager 408 may advance the destructible game object from the initial state to the one or more destructed states responsive to detecting game actions that satisfy a part requirement precondition associated with the one or more destructed states. With example embodiments, each of the part requirement preconditions may list a number parts that are to be applied to the destructible game object to facilitate the transition the state of the destructible game object to a next state (e.g., from a first destructive state to a second destructive state). When the number of parts are applied to the destructible game object, the game engine 404 may remove the number of parts from the user's inventory. In some embodiments, advancing the destructible game object from the initial state to the one or more destructed states may involve the destructible game object state manager 408 updating the visual image of the destructible game object. In some cases, the updated visual image may be relatively smaller in size than the visual image associated with the initial state.

At operation 506, responsive to detecting fulfillment of a part requirement precondition associated with the reward state, the destructible game object state manager 408 may cause the game engine 404 to replace the destructible game object with a reward object. Operation 506 may occur after the user applies additional parts to the destructible game object, which is now in one of the destructive states. The additional parts may be used to satisfy the part requirement precondition associated the reward state. Similar to the operation 504, when the additional parts are applied to the destructible game object, the game engine 404 may remove the number of parts from the user's inventory. In some embodiments, advancing the destructible game object from the destructive state to the reward state may involve the destructible game object state manager 408 updating the visual image of the destructible game object to indicate that the destructible game object is destroyed or otherwise removed. In some cases, when the destructible game object is destroyed, the location associated with the destructible game object is freed so that the user may place other game objects at the location.

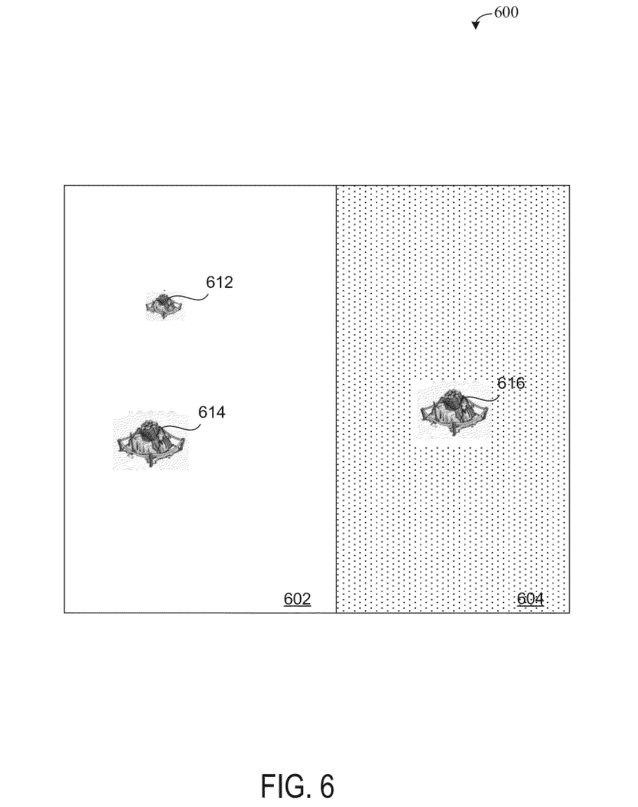

Generating destructible game objects in a game board (e.g., see the operation 502 of FIG. 5) is now discussed in greater detail. FIG. 6 is a user interface diagram illustrating a game board 600 that may utilize destructible game objects, according to an example embodiment. The game board 600 shown in FIG. 6 may include an unlocked game area 602 and a locked game area 604. The unlocked game area 602 may be an area within the game board 600 in which a user has permission to manipulate or access. For example, in some cases, a farming simulation game may allow a user to plant crops, harvest crops, place buildings or structures, or perform any other suitable game action respective to a location within the game board 600. In contrast, the locked game area 604 may be an area within the game board in which a user may have limited permissions to manipulate or access. For example, a farming simulation game may prohibit a user from planting crops, harvesting crops, placing buildings or structures, or performing any other suitable game action within the game board 600. In some cases, a user may cause the game engine 404 to update a locked game area to be an unlocked game area. The update may be caused when the user satisfies an expanding precondition tied to the locked game area. Paying a cost (e.g., coins), obtaining an experience level or point, obtaining an item, perform a task, are all examples of conditions that may satisfy an expanding precondition,

Depending on the embodiment, destructible game objects may be generated within the game board 600 such that the destructible game object is located within the unlocked game area 602, the locked game area 604, or some combination of the unlocked game area 602 and the locked game area 604. For example, the game board 600 may include destructible game objects 612, 614 located in the unlocked game area 602 and the destructible game object 616 in the locked game area 604. Thus, a user playing the game may interact with the destructible game objects 612, 614 by expending building resources but may be prohibited from doing so with the destructible game object 616. However, once the user unlocks the locked game area 604 (thereby turning the locked game area into an unlocked game area), the user may then interact with the destructible game object 616 in the same way as the destructible game objects 612, 614.

It is to be appreciated that generating a destructible game object in a locked game area may have some advantages. For example, some embodiments may generate a destructible game object in a locked game area to provide an incentive for the user to unlock the locked game area. With such an incentive, a game system may experience a greater demand for resources used to unlock game area, which may, in turn, drive sales for those resources.

Some embodiments may include features for personalizing or otherwise tuning aspects of a destructible game object according to a user profile. A user profile may be data that characterizes a user's gameplay. In some cases, the user profile may include data representing historical success rates of challenges (quests, initiating and completing buildings, and the like), a number of items in an inventory, items needed to accomplish an achievement (e.g., items needed to complete a pending task, quest, collection, building, and the like), a social connectedness of the user, historical interactions with destructible game objects, and the like.

In an example, the number of parts listed by a part requirement precondition of a destructible game object may be tuned based on the size of the user's social network (e.g., the number of friends linked to the user, a number of friends linked to the user that play the online-game, a number of friends linked to the user that interact with the user). For example, a destructible game object (or a type of destructible game object) may be associated with a baseline number of parts that must be applied to the destructible game object in order for the destructible game object to transition to the reward state. Some embodiments of the destructible game object placement module 406 may discount the baseline number of parts for the part requirement precondition based on the size user's social network being below a threshold. Additionally or alternatively, some embodiments of the destructible game object placement module 406 may increase the baseline number of parts for the part requirement precondition based on the size user's social network being above a threshold.

A size of a social network may be one factor in tuning the number of parts listed by a part requirement precondition. For example, some embodiments may factor in data regarding the success of the user in destroying past destructible game objects. If the user has been unable to successfully complete past destructible game objects, the destructible game object placement module 406 may generate a destructible game object with a number of parts that is lower than the baseline number to decrease the difficulty in destroying the destructible game object. The vice versa may be true as well. That is, if the user has successfully complete past destructible game objects (e.g., possibly in a row), the destructible game object placement module 406 may generate a destructible game object with a number of parts that is higher than the baseline number to increase the difficulty in destroying the destructible game object.

As described above, some embodiments may generate a destructible game object within a locked game area. When the player unlocks the locked area, the destructible game object within the previously locked game area may be accessible by the user. In some embodiments, the destructible game object placement module 404 may personalize the placement of a given type of destructible game object within a locked area. For example, in some embodiments, the destructible game object placement module 404 may track a user's preference in a type of destructible game object. A user's preference may be determined based on tracking whether a user completes or applies parts to one type destructible game object over another type. In embodiments that track a preferred type of destructible game object, the destructible game object placement module 404 may generate the preferred type of destructible game object in a locked game area.

In some cases, the type of reward for completing a destructible game object is tuned using the user profile. For example, when generating a destructible game object, the destructible game object placement module 404 may use any one of the following factors to associate a destructible game object with a type of reward: items previously purchased by the user, an item needed to complete a challenge, an item needed to complete a craft, an item needed to complete a collection, or any other user profile data.

It is to be appreciated that other aspects of a destructible game objects may be tuned based on user profile data and, as such, is not limited to the above examples. For example, some embodiments may additionally or alternatively tune the number of destructible game objects that generated within an unlocked game area or a locked game area. For example, for a user that has successfully completed a number of destructible game objects above a threshold number, the destructible game object placement module 404 may increase the number of destructible game objects in the game board. As another example, for a user that has a number of parts needed to satisfy a parts requirement precondition above a threshold number, the destructible game object placement module 404 may also increase the number of destructible game objects in the game board.

Example Gaming Systems

A virtual game may be hosted by the gaming system 112, which can be accessed using any suitable connection 110 with a suitable client device 104. A user may have a game account on the gaining system 112, wherein the game account may contain a variety of information associated with the user (e.g., the user's personal information, financial information, purchase history, user character state, game state, etc.). In some embodiments, a user may play multiple games on the gaming system 112, which may maintain a single game account for the user with respect to the multiple games, or multiple individual game accounts for each game with respect to the user. In some embodiments, the gaming system 112 may assign a unique identifier to a user 102 of a virtual game hosted on the gaming system 112. The gaming system 112 may determine that the user 102 is accessing the virtual game by reading the user's cookies, which may be appended to HTTP requests transmitted by the client device 104, and/or by the user 102 logging onto the virtual game.

In some embodiments, the user 102 accesses a virtual game and control the game's progress via the client device 104 (e.g., by inputting commands to the game at the client device 104). The client device 104 can display the game interface, receive inputs from the user 102, transmit user inputs or other events to the game engine, and receive instructions from the game engine. The game engine can be executed on any suitable system (such as, for example, the client device 104, the social networking system 108, or the gaming system 112). For example, the client device 104 may download client components of a virtual game, which are executed locally, while a remote game server, such as the gaming system 112, provides backend support for the client components and may be responsible for maintaining application data of the game, processing the inputs from the user 102, updating and/or synchronizing the game state based on the game logic and each input from the user 102, and transmitting instructions to the client device 104. As another example, when the user 102 provides an input to the game through the client device 104 (such as, for example, by typing on the keyboard or clicking the mouse of the client device 104), the client components of the game may transmit the user's input to the gaming system 112.

In some embodiments, the user 102 accesses particular game instances of a virtual game. A game instance is a copy of a specific game play area that is created during runtime. In some embodiments, a game instance is a discrete game play area where one or more users 102 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables.

In some embodiments, a specific game instance may be associated with one or more specific users. A game instance is associated with a specific user when one or more game parameters of the game instance are associated with the specific user. For example, a game instance associated with a first user may be named “First User's Play Area.” This game instance may be populated with the first user's PC and one or more in-game objects associated with the first user.

In some embodiments, a game instance associated with a specific user is only accessible by that specific user. For example, a first user may access a first game instance when playing a virtual game, and this first game instance may be inaccessible to all other users. In other embodiments, a game instance associated with a specific user is accessible by one or more other users, either synchronously or asynchronously with the specific user's game play. For example, a first user may be associated with a first game instance, but the first game instance may be accessed by all first-degree friends in the first user's social network.

In some embodiments, the set of in-game actions available to a specific user is different in a game instance that is associated with this user compared to a game instance that is not associated with this user. The set of in-game actions available to a specific user in a game instance associated with this user may be a subset, superset, or independent of the set of in-game actions available to this user in a game instance that is not associated with him. For example, a first user may be associated with Blackacre Farm in an online farming game, and may be able to plant crops on Blackacre Farm. If the first user accesses a game instance associated with another user, such as Whiteacre Farm, the game engine may not allow the first user to plant crops in that game instance. However, other in-game actions may be available to the first user, such as watering or fertilizing crops on Whiteacre Farm.

In some embodiments, a game engine interfaces with a social graph. Social graphs are models of connections between entities (e.g., individuals, users, contacts, friends, users, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In some embodiments, a unique client identifier may be assigned to individual users in the social graph. This disclosure assumes that at least one entity of a social graph is a user or player character in an online multiuser game.

In some embodiments, the social graph is managed by the gaining system 112, which is managed by the game operator. In other embodiments, the social graph is part of a social networking system 108 managed by a third party (e.g., Facebook, Friendster, Myspace). In yet other embodiments, the user 102 has a social network on both the gaining system 112 and the social networking system 108, wherein the user 102 can have a social network on the gaming system 112 that is a subset, superset, or independent of the user's social network on the social networking system 108. In such combined systems, game network system 112 can maintain social graph information with edge-type attributes that indicate whether a given friend is an “in-game friend,” an “out-of-game friend,” or both. The various embodiments disclosed herein are operable when the social graph is managed by the social networking system 108, the gaming system 112, or both.

### Example Systems and Methods

Returning to FIG. 2, the User 201 may be associated, connected or linked to various other users, or “friends,” within the out-of-game social network 250. These associations, connections or links can track relationships between users within the out-of-game social network 250 and are commonly referred to as online “friends” or “friendships” between users. Each friend or friendship in a particular user's social network within a social graph is commonly referred to as a “node.” For purposes of illustration, the details of out-of-game social network 250 are described in relation to User 201. As used herein, the terms “user” and “player” can be used interchangeably and can refer to any user in an online multiuser game system or social networking system. As used herein, the term “friend” can mean any node within a user's social network.

As shown in FIG. 2, Player 201 has direct connections with several friends. When Player 201 has a direct connection with another individual, that connection is referred to as a first-degree friend. In out-of-game social network 250, Player 201 has two first-degree friends. That is, Player 201 is directly connected to Friend 1₁ 211 and Friend 2₁ 221. In the social graph 200, it is possible for individuals to be connected to other individuals through their first-degree friends (e.g., friends of friends). As described above, the number of edges in a minimum path that connects a user to another user is considered the degree of separation. For example, FIG. 2 shows that Player 201 has three second-degree friends to which Player 201 is connected via Player 201's connection to Player 201's first-degree friends. Second-degree Friend 1₂ 212 and Friend 2₂ 222 are connected to Player 201 via Player 201's first-degree Friend 1₁ 211. The limit on the depth of friend connections, or the number of degrees of separation for associations, that Player 201 is allowed is typically dictated by the restrictions and policies implemented by the social networking system 108.

In various embodiments, Player 201 can have Nth-degree friends connected to him through a chain of intermediary degree friends as indicated in FIG. 2. For example, Nth-degree Friend 1_{N} 219 is connected to Player 201 within in-game social network 260 via second-degree Friend 3₂ 232 and one or more other higher-degree friends.

In some embodiments, a user (or player character) has a social graph within an online multiuser game that is maintained by the game engine and another social graph maintained by a separate social networking system. FIG. 2 depicts an example of in-game social network 260 and out-of-game social network 250. In this example, Player 201 has out-of-game connections 255 to a plurality of friends, forming out-of-game social network 250. Here, Friend 1₁ 211 and Friend 2₁ 221 are first-degree friends with Player 201 in Player 201's out-of-game social network 250. Player 201 also has in-game connections 265 to a plurality of users, forming in-game social network 260. Here, Friend 2₁ 221, Friend 3₁ 231, and Friend 4₁ 241 are first-degree friends with Player 201 in Player 201's in-game social network 260. In some embodiments, a game engine can access in-game social network 260, out-of-game social network 250, or both.

in some embodiments, the connections in a user's in-game social network is formed both explicitly (e.g., when users “friend” each other) and implicitly (e.g., when the system observes user behaviors and “friends” users to each other). Unless otherwise indicated, reference to a friend connection between two or more users can be interpreted to cover both explicit and implicit connections, using one or more social graphs and other factors to infer friend connections. The friend connections can be unidirectional or bidirectional. It is also not a limitation of this description that two users who are deemed “friends” for the purposes of this disclosure are not friends in real life (e.g., in disintermediated interactions or the like), but that can be the case.

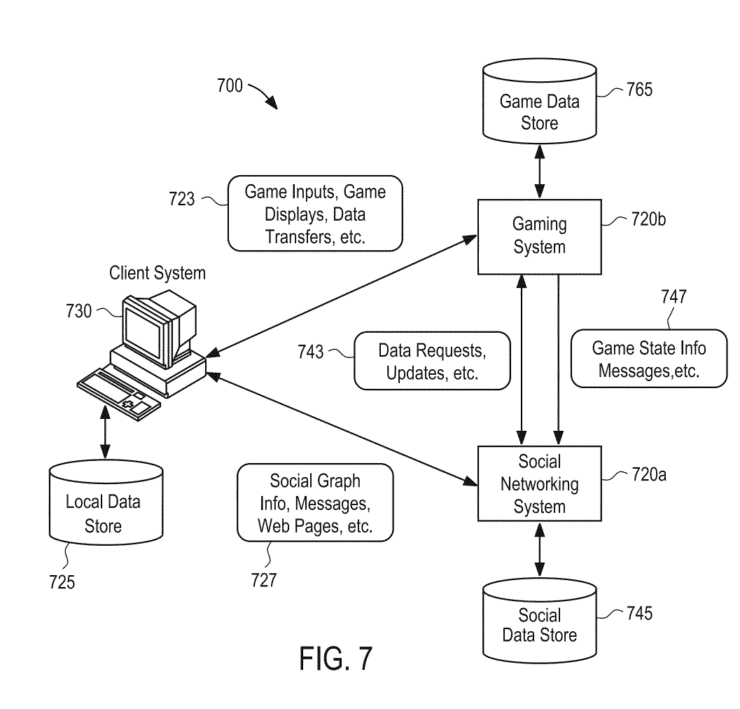

FIG. 7 illustrates an example data flow between example components of an example system 700. One or more of the components of the example system 700 may correspond to one or more of the components of the example gaming environment 100. In some embodiments, the system 700 includes a client system 730, a social networking system 720a, and a gaming system 720b. The components of system 700 can be connected to each other in any suitable configuration, using any suitable type of connection. The components may be connected directly or aver any suitable network. The client system 730, the social networking system 720a, and the gaming system 720b may have one or more corresponding data stores such as local data store 725, social data store 745, and game data store 765, respectively.

The client system 730 may receive and transmit data 723 to and from the gaming system 720b. This data can include, for example, a web page, a message, a game input, a game display, a HTTP packet, a data request, transaction information, and other suitable data. At some other time, or at the same time, the gaming system 720b may communicate data 743, 747 (e.g., game state information, game system account information, page info, messages, data requests, updates) with other networking systems, such as the social networking system 720a (e.g., Facebook, Myspace). The client system 730 can also receive and transmit data 727 to and from the social networking system 720a. This data can include, for example, web pages, messages, social graph information, social network displays, HTTP packets, data requests, transaction information, updates, and other suitable data.

Communication between the client system 730, the social networking system 720a, and the gaming system 720b can occur over any appropriate electronic communication medium or network using any suitable communications protocols. For example, the client system 730, as well as various servers of the systems described herein, may include Transport Control Protocol/Internet Protocol (TCP/IP) networking stacks to provide for datagram and transport functions. Of course, any other suitable network and transport layer protocols can be utilized.

In some embodiments, an instance of a virtual game is stored as a set of game state parameters that characterize the state of various in-game objects, such as, for example, player character state parameters, non-player character parameters, and virtual item parameters. In some embodiments, game state is maintained in a database as a serialized, unstructured string of text data as a so-called Binary Large Object (BLOB). When a user accesses a virtual game on the gaming system 720b, the BLOB containing the game state for the instance corresponding to the user may be transmitted to the client system 730 for use by a client-side executed object to process. In some embodiments, the client-side executable is a FLASH-based game, which can de-serialize the game state data in the BLOB. As a user plays the game, the game logic implemented at the client system 730 maintains and modifies the various game state parameters locally. The client-side game logic may also batch game events, such as mouse clicks, and transmit these events to the gaming system 720b. Gaming system 720b may itself operate by retrieving a copy of the BLOB from a database or an intermediate memory cache (memcache) layer. The gaming system 720b can also de-serialize the BLOB to resolve the game state parameters and execute its own game logic based on the events in the batch file of events transmitted by the client to synchronize the game state on the server side. The gaming system 720b may then re-serialize the game state, now modified into a BLOB, and pass this to a memory cache layer for lazy updates to a persistent database.

In some embodiments, a computer-implemented game is a text-based or turn-based game implemented as a series of web pages that are generated after a user selects one or more actions to perform. The web pages may be displayed in a browser client executed on the client system 730. For example, a client application downloaded to the client system 730 may operate to serve a set of web pages to a user. As another example, a virtual game may be an animated or rendered game executable as a stand-alone application or within the context of a webpage or other structured document. In some embodiments, the virtual game is implemented using Adobe Flash-based technologies. As an example, a game may be fully or partially implemented as a SWF object that is embedded in a web page and executable by a Flash media user plug-in. In some embodiments, one or more described web pages is associated with or accessed by the social networking system 720a. This disclosure contemplates using any suitable application for the retrieval and rendering of structured documents hosted by any suitable network-addressable resource or website.

Application event data of a game is any data relevant to the game (e.g., user inputs). In some embodiments, each application datum may have a name and a value, and the value of the application datum may change (e.g., be updated) at any time. When an update to an application datum occurs at the client system 730, either caused by an action of a game user or by the game logic itself the client system 730 may need to inform the gaming system 720b of the update. For example, if the game is a farming game with a harvest mechanic (such as Zynga FarmVille), an event can correspond to a user clicking on a parcel of land to harvest a crop. In such an instance, the application event data may identify an event or action (e.g., harvest) and an object in the game to which the event or action applies.

In some embodiments, one or more objects of a game is represented as an Adobe Flash object. Flash may manipulate vector and raster graphics, and supports bidirectional streaming of audio and video. “Flash” may mean the authoring environment, the user, or the application files. In some embodiments, the client system 730 may include a Flash client. The Flash client may be configured to receive and run Flash application or game object code from any suitable networking system (such as, for example, the social networking system 720a or the gaming system 720b). In some embodiments, the Flash client is run in a browser client executed on the client system 730. A user can interact with Flash objects using the client system 730 and the Flash client. The Flash objects can represent a variety of in-game objects. Thus, the user may perform various in-game actions on various in-game objects by making various changes and updates to the associated Flash objects.

In some embodiments, in-game actions are initiated by clicking or similarly interacting with a Flash object that represents a particular in-game object. For example, a user can interact with a Flash object to use, move, rotate, delete, attack, shoot, or harvest an in-game object. This disclosure contemplates performing any suitable in-game action by interacting with any suitable Flash object. In some embodiments, when the user makes a change to a Flash object representing an in-game object, the client-executed game logic may update one or more game state parameters associated with the in-game object. To ensure synchronization between the Flash object shown to the user at the client system 730, the Flash client may send the events that caused the game state changes to the in-game object to the gaming system 720b. However, to expedite the processing and hence the speed of the overall gaining experience, the Flash client may collect a batch of some number of events or updates into a batch file. The number of events or updates may be determined by the Flash client dynamically or determined by the gaming system 720b based on server loads or other factors. For example, client system 730 may send a batch file to the gaming system 720b whenever 50 updates have been collected or after a threshold period of time, such as every minute.

As used herein, the term “application event data” may refer to any data relevant to a computer-implemented virtual game application that may affect one or more game state parameters, including, for example and without limitation, changes to user data or metadata, changes to user social connections or contacts, user inputs to the game, and events generated by the game logic. In some embodiments, each application datum has a name and a value. The value of an application datum may change at any time in response to the game play of a user or in response to the game engine (e.g., based on the game logic). In some embodiments, an application data update occurs when the value of a specific application datum is changed.

In some embodiments, when a user plays a virtual game on the client system 730, the gaming system 720b serializes all the game-related data, including, for example and without limitation, game states, game events, user inputs, for this particular user and this particular game into a BLOB and may store the BLOB in a database. The BLOB may be associated with an identifier that indicates that the BLOB contains the serialized game-related data for a particular user and a particular virtual game. In some embodiments, while a user is not playing the virtual game, the corresponding BLOB may be stored in the database. This enables a user to stop playing the game at any time without losing the current state of the game the user is in. When a user resumes playing the game next time, gaming system 720b may retrieve the corresponding BLOB from the database to determine the most-recent values of the game-related data. In some embodiments, while a user is playing the virtual game, the gaming system 720b also loads the corresponding BLOB into a memory cache so that the game system may have faster access to the BLOB and the (same-related data contained therein.

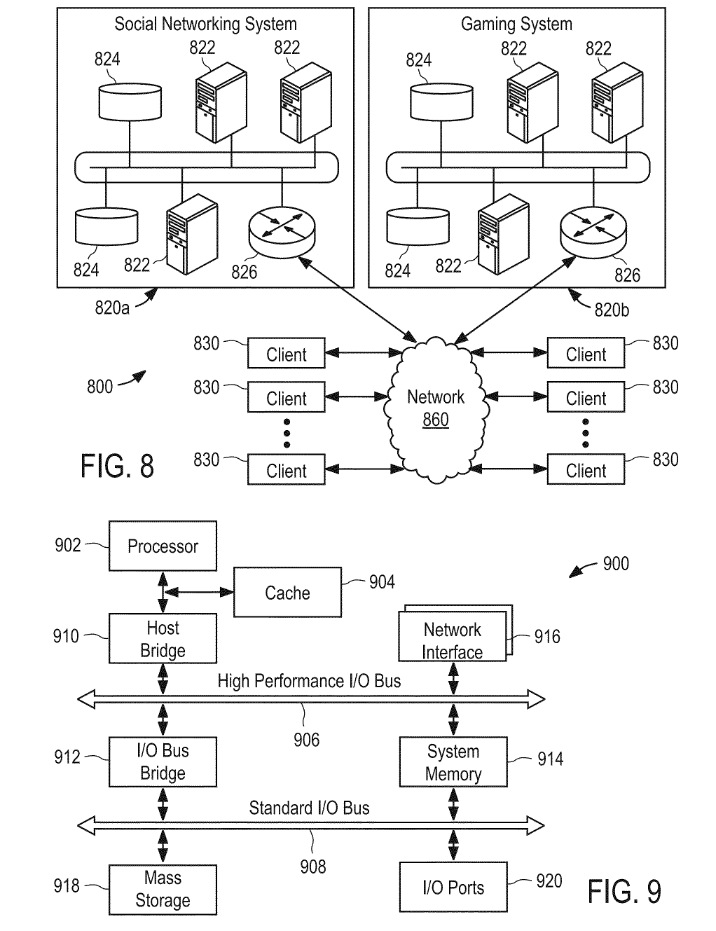

Various embodiments may operate in a wide area network environment, such as the Internet, including multiple network addressable systems. FIG. 8 illustrates an example network environment 800, in which various example embodiments may operate. Network cloud 860 generally represents one or more interconnected networks, over which the systems and hosts described herein can communicate. The network cloud 860 may include packet-based wide area networks (such as the Internet), private networks, wireless networks, satellite networks, cellular networks, paging networks, and the like. As FIG. 7 illustrates, various embodiments may operate in a network environment 800 comprising one or more networking systems, such as a social networking system 820a, a gaming system 820b, and one or more client systems 830. The components of the social networking system 820a and the gaming system 820b operate analogously; as such, hereinafter they may be referred to simply as the networking system 820. The client systems 830 are operably connected to the network environment 800 via a network service provider, a wireless carrier, or any other suitable means.

The networking system 820 is a network addressable system that, in various example embodiments, comprises one or more physical servers 822 and data stores 824. The one or more physical servers 822 are operably connected to the computer network cloud 860 via, by way of example, a set of routers and/or networking switches 826. In an example embodiment, the functionality hosted by the one or more physical servers 822 may include web or HTTP servers, FTP servers, as well as, without limitation, webpages and applications implemented using Common Gateway Interface (CGI) script, PHP Hyper-text Preprocessor (PHP), Active Server Pages (ASP), Hyper-Text Markup Language (HTML), Extensible Markup Language (XML), Java, JavaScript, Asynchronous JavaScript and XML (AJAX), Flash, ActionScript, and the like.

The physical servers 822 may host functionality directed to the operations of the networking system 820. Hereinafter, the servers 822 may be referred to as server 822, although the server 822 may include numerous servers hosting, for example, the networking system 820, as well as other content distribution servers, data stores, and databases. The data store 824 may store content and data relating to, and enabling, operation of, the networking system 820 as digital data objects. A data object, in some embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, etc.

Logically, the data store 824 corresponds to one or more of a variety of separate and integrated databases, such as relational databases and object-oriented databases that maintain information as an integrated collection of logically related records or files stored on one or more physical systems. Structurally, the data store 824 may generally include one or more of a large class of data storage and management systems. In some embodiments, the data store 824 may be implemented by any suitable physical system(s) including components, such as one or more database servers, mass storage media, media library systems, storage area networks, data storage clouds, and the like. In one example embodiment, the data store 824 includes one or more servers, databases (e.g., MySQL), and/or data warehouses. Data store 824 may include data associated with different networking system 820 users and/or client systems 830.

The client system 830 is generally a computer or computing device including functionality for communicating (e.g., remotely) over a computer network. The client system 830 may be a desktop computer, laptop computer, personal digital assistant (PDA), in- or out-of-car navigation system, smart phone or other cellular or mobile phone, or mobile gaming device, among other suitable computing devices. The client system 830 may execute one or more client applications, such as a Web browser.

When a user at the client system 830 desires to view a particular webpage (hereinafter also referred to as target structured document) hosted by the networking system 820, the user's web browser, or other document rendering engine or suitable client application, formulates and transmits a request to the networking system 820. The request generally includes a URL or other document identifier as well as metadata or other information. By way of example, the request may include information identifying the user, a timestamp identifying when the request was transmitted, and/or location information identifying a geographic location of the user's client system 830 or a logical network location of the user's client system 830.

Although the example network environment 800 described above and illustrated in FIG. 7 is described with respect to the social networking system 820a and the gaming system 820b, this disclosure encompasses any suitable network environment using any suitable systems. For example, a network environment may include online media systems, online reviewing systems, online search engines, online advertising systems, or any combination of two or more such systems.

FIG. 9 illustrates an example computing system architecture, which may be used to implement a server 922 or a client system 930. In one embodiment, the hardware system 900 comprises a processor 902, a cache memory 904, and one or more executable modules and drivers, stored on a tangible computer-readable storage medium, directed to the functions described herein. Additionally, the hardware system 900 may include a high performance input/output (I/O) bus 906 and a standard I/O bus 908. A host bridge 910 may couple the processor 902 to the high performance I/O bus 906, whereas the I/O bus bridge 912 couples the two buses 906 and 908 to each other. A system memory 914 and one or more network/communication interfaces 916 may couple to the bus 906. The hardware system 900 may further include video memory (not shown) and a display device coupled to the video memory. Mass storage 918 and I/O ports 920 may couple to the bus 908. The hardware system 900 may optionally include a keyboard, a pointing device, and a display device (not shown) coupled to the bus 908. Collectively, these elements are intended to represent a broad category of computer hardware systems.

The elements of the hardware system 900 are described in greater detail below. In particular, the network interface 916 provides communication between the hardware system 900 and any of a wide range of networks, such as an Ethernet (e.g., IEEE 802.3) network, a backplane, etc. The mass storage 918 provides permanent storage for the data and programming instructions to perform the above-described functions implemented in servers 922 of FIG. 9, whereas system memory 914 (e.g., DRAM) provides temporary storage for the data and programming instructions when executed by the processor 902. I/O ports 920 are one or more serial and/or parallel communication ports that provide communication between additional peripheral devices, which may be coupled to the hardware system 900.

The hardware system 900 may include a variety of system architectures and various components of the hardware system 900 may be rearranged. For example, cache memory 904 may be on-chip with the processor 902. Alternatively, the cache memory 904 and the processor 902 may be packed together as a “processor module,” with processor 902 being referred to as the “processor core,” Furthermore, certain embodiments of the present disclosure may neither require nor include all of the above components. For example, the peripheral devices shown coupled to the standard I/O bus 908 may couple to the high performance I/O bus 906. In addition, in some embodiments, only a single bus may exist, with the components of the hardware system 900 being coupled to the single bus. Furthermore, the hardware system 900 may include additional components, such as additional processors, storage devices, or memories,

An operating system manages and controls the operation of the hardware system 900, including the input and output of data to and from software applications (not shown). The operating system provides an interface between the software applications being executed on the system and the hardware components of the system. Any suitable operating system may be used.

Furthermore, the above-described elements and operations may comprise instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions may be executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

One or more features from any embodiment may be combined with one or more features of any other embodiment without departing from the scope of the disclosure.

A recitation of “a”, “an,” or “the” is intended to mean “one or more” unless specifically indicated to the contrary. In addition, it is to be understood that functional operations, such as “awarding”, “locating”, “permitting” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., cellular phone, smart phone, personal GPS, personal digital assistance, personal gaming device, etc.), that makes API calls directly to a server. Still further, while the embodiments described above operate with business-related game objects such as stores and restaurants), the embodiments can be applied to any in-game asset around which a harvest mechanic is implemented, such as a virtual stove, a plot of land, and the like. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. A computer-implemented method, comprising:
generating a destructible game object within a game board assigned to a user, the destructible game object being represented by an initial state, one or more destructed states, and a reward state,
advancing the destructible game object from the initial state to the one or more destructed states responsive to detecting a game action that satisfies a part requirement precondition associated with the one or more destructed states; and
responsive to detecting fulfillment of a part requirement precondition associated with the reward state, replacing the destructible game object with a reward object.

2. The computer-implemented method of claim 1, wherein advancing the destructible game object from the initial state to the one or more destructed states includes updating a visual representation of the destructible game object to occupy less space in the game board.

3. The computer-implemented method of claim 2, wherein space in the game board is measured in numbers of tiles within a grid.

4. The computer-implemented method of claim 1, wherein the game action applies a number of parts front an inventory of a user to the destructible game object.

5. The computer-implemented method of claim 1, wherein replacing the destructible game object with a reward object completes a task in a quest mechanic.

6. The computer-implemented method of claim 5, further comprising, prior to detecting the occurrence of the game action, receiving the number of parts from a response to a request for parts sent to a friend of the user.

7. The computer-implemented method of claim 1, wherein the destructible game object is generated within an unlocked game area of the game board.

8. The computer-implemented method of claim 1, wherein the destructible game object is generated within a locked game area of the game board.

9. The computer-implemented method of claim 8, wherein advancing the destructible game object from the initial state to the one or more destructed states is permitted once the locked game area is unlocked by the user.

10. The computer-implemented method of claim 1, wherein replacing the destructible game object comprises selecting the reward object based on profile data associated with the user.

11. A computer-implemented system, comprising:
a destructible game object placement module implemented by one or more processors and configured to generate a destructible game object within a game board assigned to a user, the destructible game object being represented by an initial state, one or more destructed states, and a reward state,
a destructible game object state manager implemented by the one or more processors and configured to:
advance the destructible game object from the initial state to the one or more destructed states responsive to detecting a game action that satisfies a part requirement precondition associated with the one or more destructed states; and
responsive to detecting fulfillment of a part requirement precondition associated with the reward state, replace the destructible game object with a reward object.

12. The computer-implemented system of claim 11, wherein the destructible game object state manager is configured to advance the destructible game object from the initial state to the one or more destructed states by updating a visual representation of the destructible game object to occupy less space in the game board.

13. The computer-implemented system of claim 12, wherein space in the game board is measured in numbers of tiles within a grid.

14. The computer-implemented system of claim 11, wherein the game action applies a number of parts from an inventory of a user to the destructible game object.

15. The computer-implemented system of claim 11, wherein replacing the destructible game object with a reward object completes a task in a quest mechanic.

16. The computer-implemented system of claim 15, wherein the destructible game object state manager is further configured to, prior to detecting the occurrence of the game action, receiving the number of parts from a response to a request for parts sent to a friend of the user.

17. The computer-implemented system of claim 11, wherein the reward object is of a type determined based on user profile data.

18. The computer-implemented system of claim 11, wherein the destructible game object is generated within a locked game area of the game board.

19. The computer-implemented system of claim 11, wherein the part requirement precondition specifies a number of parts, the number being determined based on a size of a social network to which the user belongs.

20. A non-transitory computer-readable medium storing executable instructions thereon, which, when executed by a processor, cause the processor to perform operations comprising:
generating a destructible game object within a game board assigned to a user, the destructible game object being represented by an initial state, one or more destructed states, and a reward state,
advancing the destructible game object from the initial state to the one or more destructed states responsive to detecting a game action that satisfies a part requirement precondition associated with the one or more destructed states; and
responsive to detecting fulfillment of a part requirement precondition associated with the reward state, replacing the destructible game object with a reward object.
